(19) United States
(12) Patent Application Publication
(10) Pub. No.: US 2013/0036610 A1
(43) Pub. Date: Feb. 14, 2013

(54) Notchless Core

(71) Applicant: Richard Steven Paoletti, Spencerport, NY (US)

(72) Inventor: Richard Steven Paoletti, Spencerport, NY (US)

(21) Appl. No.: 13/205,253

(22) Filed: Aug. 8, 2011

(51) Int. Cl. B23P 17/00

(52) U.S. Cl. 29/895.2

(57) ABSTRACT

Providing a spool end with a flange, a post, and a blade on the post which extends to the flange. The post is inserted into a core including penetrating the core with the blade. The spool end is rotated including imparting a rotating force upon the core using the blade. Preferably, at least three blades are used for stability and even transmission of rotational force.

### CROSS REFERENCE TO RELATED APPLICATIONS

Reference is made to commonly assigned, co-pending U.S. patent application Ser. No. ______ by Richard S. Paoletti. (Docket 96724) filed of even date herewith entitled “Notchless Core”, the disclosure of which is incorporated herein by reference in its entirety.

### FIELD OF THE INVENTION

The present application is directed to a method and apparatus for providing rotational force upon objects accessible via an opening having an inner diameter.

### BACKGROUND OF THE INVENTION

Rolled material supplied on full length spools or, optionally, on one or more spool ends typically require a core, a spool, or spool ends, formed for fitting on a complementary shaped rotating drive device such as providing a notch in the core for engaging a surface feature of the drive device, often referred to as a notch and key design. These are easy to use but can be expensive. Other methods include using a flange with both keys and straight ribs to transmit torque. These are difficult to use due to the force required to insert the flanges into the core. Roll fed printers that use cardboard cores for supplying wound media are an example. The cardboard core defines an inner diameter opening having a soft material core. Prior art approaches in this regard have relied on frictional engagement between a rotational drive means to transmit torque to the core/roll. This would require a certain amount of force to insert and remove the rolled media. Reduction of the insertion force has been achieved in other prior art by means of a spring loaded expansion of the roll after insertion. Other prior art methods involve blades fastened to a tube which is inserted into a media roll and engage the core at points near the middle of the length of the roll which also requires some manual effort to insert.

### SUMMARY OF THE INVENTION

Roll fed printers that use cardboard cores for supplying wound media are an example application of the means and methods of the present invention. The present invention does not rely on friction to transmit torque to the roll, thereby providing a more positive drive than frictional engagement, does not penetrate the core to any significant distance, and is simpler in construction.

This can eliminate the need for a notched core for a roll of paper, for example. The notch feature can add significant expense to the core. The angle of the rib (blade) in the present invention allows for easy insertion and removal of the flanges into the core as opposed to other designs which require considerable force. By the use of angled ribs on the drive flange which penetrate into a soft core, such as cardboard, to transmit torque to the core. Media manufacturing cost is reduced due to elimination of core notching.

A preferred embodiment of the present invention comprises a method comprising providing a spool end with a flange and a post. A blade on the post extends to the flange. The post is inserted into a core including penetrating the core with the blade, preferably in a radial direction. When inserted the core abuts the flange. The blade is disposed at an angle to the post such that the blade further penetrates the core as the post is further inserted into the core. The spool end is rotated including imparting a rotating force upon the core using the blade. Additional blades can be used on the post with each additional blade extending from the flange to the post. Preferably, at least three blades are used for stability and even transmission of rotational force. The blade or blades can optionally be disposed in a non-radial direction.

Another preferred embodiment of the present invention comprises a method including inserting a post into a hollow core having rolled material wound thereon, and slicing into a portion of an interior diameter of the hollow core using a blade positioned on the post. Maintaining a position of the hollow core on the on the driving post keeps the blade in the hollow core. Rotating the post and the blade positioned on the post, including rotating the hollow core of rolled material, provides a rotational force by the blade against the hollow core of rolled material. The step of rotating can comprise controllably rotating the post for rotating the core and controllably stopping the rotation of the post for stopping rotation of the hollow core. A flange on the post limits an insertion distance of the post into the hollow core. The drive post is inserted into a first end of the hollow core and a support post can support a second end of the hollow core.

Another preferred embodiment of the present invention comprises a method including forming a rib on a spool end, wherein the spool end is configured to be inserted into one end of a core of a spool and the rib is configured to cut and penetrate an inside diameter of one end of the core and remains penetrated so long as the spool remains on the spool end. The spool end is inserted into one end of the core and is rotated to rotate the spool typically to unwind the material off of the spool. The rib can be shaped to a height of about 0.20 inches and a length of about 0.25 inches extending in a radial direction from the spool end. Its height is less than a thickness of the core of the spool and its cutting edge forms an angle with respect to a length of the spool of about four to about five degrees. A second spool end (support spool) is configured to be inserted into a second end of the core of the spool and can be rotatable or stationary.

These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. For example, the summary descriptions above are not meant to describe individual separate embodiments whose elements are not interchangeable. In fact, many of the elements described as related to a particular embodiment can be used together with, and possibly interchanged with, elements of other described embodiments. Many changes and modifications may be made within the scope of the present invention without departing from the spirit thereof, and the invention includes all such modifications. The figures below are intended to be drawn neither to any precise scale with respect to relative size, angular relationship, or relative position, nor to any combinational relationship with respect to interchangeability, substitution, or representation of an actual implementation.

### BRIEF DESCRIPTION OF THE DRAWINGS

FIGS. 1A-B illustrate a preferred embodiment of the present invention.

FIG. 2 illustrates a media roll with a drive spool and support spool.

### DETAILED DESCRIPTION OF THE INVENTION

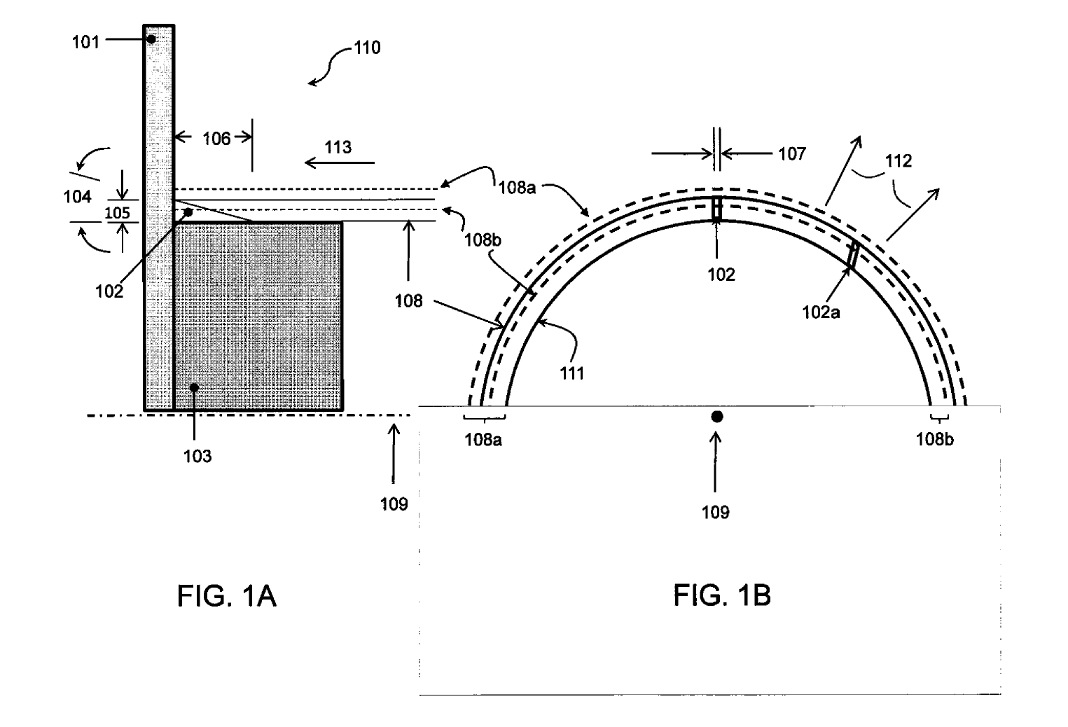

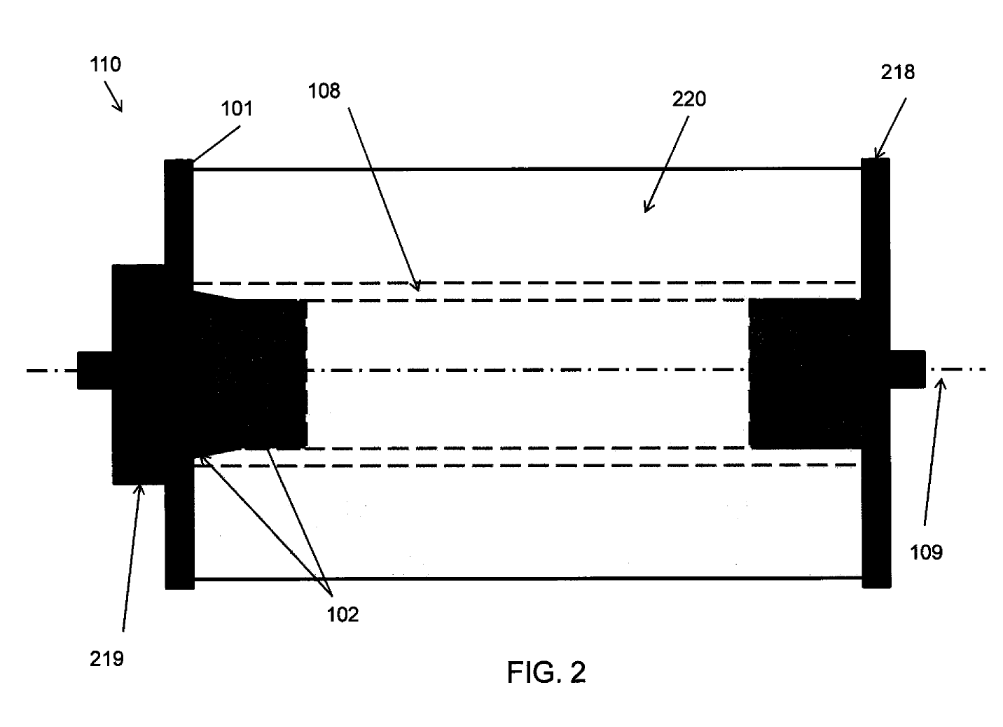

FIGS. 1A and 1B illustrate a cross-section front view and a side view, respectively, of a preferred embodiment of the present invention wherein a spool end 110, comprising a flange portion 101 attached to, or formed integrally with, substantially orthogonal post 103, is provided with a blade, or rib, 102 that penetrates a hollow core 108 in order to transmit a rotational force (torque) to the core when the spool end is rotated by a motor (not shown) around rotational axis 109. The blade as illustrated in FIG. 1A show a side profile of the blade which presents a triangular side surface of the blade which is in contact with the core 108 due to the blade penetrating the core. This surface area presses against the core when the flange/post assembly is rotated and so transmits rotational force to the core and any material wound thereon or attached thereto. The exposed, angled edge of the blade which contacts the core as the core is positioned on the post is referred to herein as the cutting edge. FIGS. 1A-1B illustrate one end of a hollow core 108 whose other end can be similarly constructed and also coupled to a post with or without a flange and with or without a blade as disclosed herein below with respect to FIG. 2. While the post and blade configuration disclosed herein is designed to co-rotate with the core and material wound thereon, the other end of the hollow core can be similarly constructed or it can be designed to slidably rotate around a stationary post. The blade is also affixed, attached, or formed integrally with, either, or both, the flange and the post. The blade first penetrates inner diameter 111 of the hollow core as the hollow core is positioned onto post 103 or as the post is inserted into the hollow core. Inner diameter 111 also represents the interior surface of hollow core 108 wherein the post is disposed. An opposite external surface is used for winding media or other material onto the hollow core. A greater height 105 of blade 102 results in a greater distance that the blade will penetrate the core. In the side view of FIG. 1B, the flange 101 is not shown for purposes of clarity and the cross-section of the core 108 is shown to be circular, though this configuration is not a requirement. An outside diameter of post 103 is also circular to provide a good fit with, and is substantially equivalent to, the inside diameter 111 of hollow core 108 to provide stable and secure angular velocity thereto. Blade 102 penetrates core 108 when the post 103 is inserted into core 108 by sliding core 108 in direction 113 onto post 103. The blade 102 can extend from the core radially, parallel to example radially extending lines 112, or it can be disposed to extend from the core in a non-radial direction as shown by example blade 102a. The radial direction 112 aligns the blade along a line that intersects rotational axis 109. Preferably, the blade extends from the post to the flange at an angle 104 facilitating easy positioning of the core onto the post to effect penetration of the blade into the core. This angle can be measured with reference to the rotational axis 109 or to the length of the core 108. Typically wound around hollow core 108 is media (not shown) whose rolled depth around core 108 can extend up to, less than, or beyond the end of flange 101, often referred to as a spool of media. The flange also serves as a terminus for the core, or spool, when the core is positioned on, or slid onto, the post and abuts the flange. Dotted line 108a indicates an optional thickness of core 108 which can extend beyond the height 105 of blade 102. Dotted line 108b indicates that the thickness of core 108 can be less than the height 105 of blade 102. If it is less than the height of blade 102 then the blade can also penetrate material rolled onto core 108. It should be noted that a core is not required in order to implement the present invention, and that the post extension 103 and blade 102 can engage rolled material without a core. In such a case the blade 102 will penetrate the rolled material directly. In such a case the rolled material without a core can be directly represented as element 108, 108a, or 108b, in FIGS. 1A and 1B. The length 106 and width 107 of the blade, or rib, 102 are described below.

FIGS. 1A and 1B are not intended to limit the configuration shown to a single spool end for driving core+rolled material or only rolled material. Another end of core 108 can also be fitted onto a similar bladed or non-bladed spool end 110, as illustrated in FIG. 2, disposed to rotate coaxially with the spool end 110 or to remain stationary as core 108 rotates about it. In such a configuration, spool end 110 or both spool ends can be motor driven to rotate the core and rolled material around axis 109. Similarly, multiple blades (not shown) similar to, or different from, blade 102 can be disposed around post, or extension, 103 to penetrate, engage, and provide rotational force to core 108 at multiple penetration points. In a preferred embodiment of the present invention, a minimum of three multiple blades are disposed at equidistant angular distances around the circumference of post 103 to insure stability and concentricity between the spool and core. The material wound around core 108 may be a continuous sheet of media, or it may comprise multiple individual sheets, or perforated sections, or other configurations of material, having a wide range of possible thicknesses. While the environment of the present invention was conceived and tested in the context of printer media, the invention is not limited thereto. The present invention comprises an apparatus and method of engaging a rotatable post to a hollow core for any application requiring such a configuration. While the material surrounding post 103 has been described as wound thereon, it need not be so configured. The material can be attached to post 103, such as by adhesives, and the material itself may comprise an apparatus used for rollably applying liquids to surfaces and other objects, for example. Other uses of the presently described apparatus and method invention are considered part of the present invention.

FIG. 2 illustrates the bladed drive spool 110, described above, at one end of core 108 and a second bladed or non-bladed support spool 218, shown as non-bladed, disposed at the other end of core 108. The bladed drive spool 110 is shown with multiple blades 102. Media 220 is shown wound around core 108 to a depth slightly less than the end of flange 101. Drive gear or pulley 219 for rotating the flange/post assembly is also illustrated and is not explained further.

Without limiting any dimensions in any manner whatsoever the elements shown in the Figures, the following are examples of the dimensions of preferred embodiments of the present invention as tested and designed by the inventors of the present invention, referring generally to FIGS. 1A and 1B and the description above.

The Core ID was tested using a prototype of 3.009 inches with tolerance +/−0.008 inches. The mating post diameter was made at 2.995 inches with tolerance of +/−0.005 inches. Max core ID was determined to be 3.017 inches with materials available and Min flange OD was determined to be 2.990 inches with materials on hand. If the blade height is 0.020, the effective minimum flange OD is 3.030 to 3.040 inches, with resulting dimensions as follows:
minimum blade engagement=(3.030−3.017)/2=0.013/2=0.0065″
maximum blade engagement=(3.04−3.001)/2=0.039/2=0.0195″

The length and height of the blade can vary but should form an angle 104 of approximately 4 to 5 degrees with the axis of rotation 109 of the spool to minimize insertion force. Thus, in the above example of a blade height of 0.020″, the length of the rib 106 would be approximately 0.25″.

The thickness of the rib 107 should be kept to a minimum to minimize insertion force but will depend on the rib material strength, hardness of the core it is being inserted into, and the torque transmitted per rib. A typical thickness would be 0.016″ to 0.020″ for use with a cardboard core.

The invention has been described in detail with particular reference to certain preferred embodiments thereof, but it will be understood that variations and modifications can be effected within the spirit and scope of the invention.

### PARTS LIST

101 Flange

102 Blade

102a Blade

103 Extension

104 Angle

105 Height

106 Length

107 Width

108 Core Thickness

108a Core Thickness

108b Core Thickness

109 Axis

110 Drive Spool

111 Inner Diameter

112 Radial Direction

113 Direction

218 Support Spool

219 Motor or Pulley

220 Media Roll

1. Method comprising:
providing a spool end, the spool end comprising a flange and a post; and
disposing a blade on the post, the blade extending from the flange to the post.

2. The method of claim 1 further comprising the step of inserting the post into a core including penetrating the core with the blade in a radial direction.

3. The method of claim 2 further comprising the step of rotating the spool end including the blade imparting a rotating force upon the core.

4. The method of claim 2 wherein the step of inserting comprises the step of abutting the core against the flange.

5. The method of claim 2, wherein the step of disposing comprises disposing the blade at an angle to the post such that the blade further penetrates the core as the post is further inserted into the core.

6. The method of claim 1, wherein the step of disposing comprises disposing at least one more additional blade on the post, each additional blade extending from the flange to the post.

7. The method of claim 1 further comprising the step of inserting the post into a core including penetrating the core with the blade in a non-radial direction.

8. Method comprising:
inserting a drive post into a hollow core having rolled material wound thereon including slicing into a portion of an interior diameter of the hollow core using a blade positioned on the post; and
maintaining a position of the hollow core such that it remains on the drive post with the blade therein.

9. Method of claim 8 further comprising rotating the post and the blade positioned on the post, including rotating the hollow core of rolled material, wherein the blade provides a rotational force against the hollow core of rolled material.

10. Method of claim 8 wherein the step of rotating comprises controllably rotating the post and the blade positioned thereon including controllably stopping the rotation of the post and the blade positioned thereon, wherein the blade provides a rotational force against the hollow core of rolled material during the step of controllably rotating, and wherein the blade provides a stopping force against a rotation of the hollow core of rolled material during the step of controllably stopping the rotation.

11. Method of claim 8 further comprising providing a flange on the post for limiting an insertion distance of the drive post into the hollow core.

12. Method of claim 8 wherein the drive post is inserted into a first end of the hollow core having rolled material wound thereon and further comprising providing a support post for supporting a second end of the hollow core having rolled material wound thereon.

13. Method comprising:
forming a rib on a spool end, wherein the spool end is configured to be inserted into one end of a core of a spool and the rib is configured to cut and penetrate an inside diameter of the one end of the core of the spool and to remain penetrated at the one end of the core so long as the spool remains on the spool end;
inserting the spool end into the core of the spool; and
rotating the spool end, whereby the spool rotates.

14. Method of claim 13, wherein the spool rotates in a direction for unwinding the material off of the spool.

15. Method of claim 13 further comprising forming the rib having a height of about 0.20 inches and a length of about 0.25 inches.

16. Method of claim 15 further comprising forming the rib such that it extends in a radial direction from the spool end.

17. Method of claim 13 further comprising forming the rib such that its cutting edge forms an angle with respect to a length of the spool of about four to about five degrees.

18. Method of claim 15, wherein the height is less than a thickness of the core of the spool.

19. Method of claim 13, further comprising forming a second spool end configured to be inserted into a second end of the core of the spool.

20. Method of claim 19, wherein during the step of rotating the spool end, the second spool end rotates.
